(19) United States
(12) Patent Application Publication
(10) Pub. No.: US 2007/0273353 A1
(43) Pub. Date: Nov. 29, 2007

(54) Power supply sense circuit, power supply system and integrated circuit

(75) Inventor: Koji Okamoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/520,733

(22) Filed: Sep. 14, 2006

(30) Foreign Application Priority Data
May 9, 2006 (JP) 2006-130395

(51) Int. Cl. H02M 5/257

(52) U.S. Cl. 323/324

(57) ABSTRACT

The present invention relates to a technique capable of reliably detecting supply voltages at a plurality of points in an integrated circuit with a simple arrangement and improving the setting accuracy of a supply voltage to the integrated circuit irrespective of position in the interior of the integrated circuit. The integrated circuit internally includes a plurality of voltage sense points, a selection circuit connected to each of the plurality of voltage sense points for selecting one of the plurality of voltage sense points on the basis of an input signal, and a voltage sense terminal connected to the selection circuit for outputting a voltage of the one voltage sense point, selected by the selection circuit, to the exterior of the integrated circuit.

### BACKGROUND OF THE INVENTION

1) Field of the Invention

The present invention relates to a technique for supplying predetermined electric power to an integrated circuit (for example, LSI (Large Scale Integration)), and more particularly to a technique for improving the setting accuracy of a supply voltage to an integrated circuit requiring large power consumption.

2) Description of the Related Art

So far, for the detection (which will hereinafter be referred equally as to “sense”) of a supply voltage to an integrated circuit (for example, LSI), there has been known a technique for setting a supply voltage to an integrated circuit at a desired value.

For example, this technique is for use in an evaluation test which is for examining voltage levels, whereby an integrated circuit operates normally, according to processing speeds.

In this connection, as a technique for detecting a supply voltage to an integrated circuit, there has been known a conventional technique (for example, see the following Patent Document 1) which is made to measure a comparison reference voltage of each of a plurality of comparators in an integrated circuit while changing over a switch.

FIG. 5 is an illustration for explaining a conventional technique for sensing and setting a supply voltage to an integrated circuit. In a power supply system 100 shown in FIG. 5, an LSI (integrated circuit) 110 is mounted on a substrate 101.

In addition, for receiving the power supply, the substrate 101 has a power terminal 102 and a GND (ground) terminal 103. The power terminal 102 is connected to a VDD outputting section 121 of a power supply unit 120 while the GND terminal 103 is connected to a GND outputting section 122 of the power supply unit 120, so the substrate 101 receives the supply of power from the power supply unit 120.

Moreover, for outputting a power supply voltage (voltage value) to the external, the substrate 101 has a first power supply voltage sense terminal 104 and a first GND voltage sense terminal 105. The first power supply voltage sense terminal 104 is connected to a VDD sense section 123 of the power supply unit 120 while the first GND voltage sense terminal 105 is connected to a GND sense section 124 of the power supply unit 120. Thus, the voltage in the substrate 101 (in this case, a supply voltage to the LSI 110) is sensed through the first power supply voltage sense terminal 104 and the first GND sense terminal 105 in the power supply unit 120.

The LSI 110 mounted on the substrate 101 has a plurality of signal terminals (in the illustration, see cells marked with “S”) and further includes one of a plurality of power supply terminals (in the illustration, see cells marked with “V”) as a second power supply voltage sense terminal 111 (in the illustration, see cells marked with “VS”) and one of a plurality of GND terminals (in the illustration, see cells marked with “G”) as a second GND power supply sense terminal 112 (in the illustration, see cells marked with “GS”).

In addition, the second power supply voltage sense terminal 111 and the second GND sense terminal 112 are for sensing a supply voltage to output it to the exterior of the LSI 110. The second power supply voltage sense terminal 111 is connected to the first power supply voltage sense terminal 104 through wiring on the substrate 101 while the second GND sense terminal 112 is connected to the first GND sense terminal 105 through wiring on the substrate 101.

Still additionally, the power supply terminals of the LSI 110 are connected to a power supply terminal 102 of the substrate 101 through wiring )not shown) on the substrate 101 while the GND terminals of the LSI 110 are connected to a GND terminal 103 of the substrate 101 through wiring (not shown) on the substrate 101.

With this arrangement, a voltage value of the LSI 110 is detected by the second power supply voltage sense terminal 111 and the second GND sense terminal 112, and outputted through the first power supply voltage sense terminal 104 and the first GND sense terminal 105 to the VDD sense section 123 and the GND sense section 124 in the power supply unit 120 to be sensed by the power supply unit 120.

Yet additionally, the power supply unit 120, which has sensed the supply voltage to the LSI 110, is made to adjust the supply voltage to the LSI 110 to a desired value on the basis of the voltage value thereof.

Accordingly, in the power supply system 100 shown in FIG. 5, in the case of making an evaluation as to whether or not the LSI 110 operates normally, for example, when a voltage of 1V is applied thereto, the actual supply voltage value in the LSI 110 can be set at a voltage value (1V) for a test on the basis of a voltage value sensed through the second power supply voltage sense terminal 111 and the second GND voltage sense terminal 112 in the LSI 110, by the power supply unit 120.

However, in the case of a recent-years integrated circuit requiring large power consumption, for example, as shown in FIG. 6, a circuit block is divided into a plurality of blocks 113a to 113i. Since the power to be consumed varies sharply according to the scale or operation contents of the circuit blocks 113a to 113i to be tested, the voltage to be supplied varies according to a physical position in the interior of the LSI 110.

Therefore, as shown in FIGS. 5 and 6, when the power supply unit 120 determines a supply voltage on the basis of only a supply voltage at one point sensed through the second power supply voltage sense terminal 111 and the second GND voltage sense terminal 112 in the interior of the LSI 110, an error arises between the actual supply voltage value and a voltage for a test at a position different from this one point.

For example, in the LSI 110, in a case in which a difference exists between a voltage value at this one point and a voltage value of the circuit block 113i of the fifth memory, also in the circuit block 113i of the fifth memory, an error arises between the actual supply voltage value and the voltage value for test.

This error causes degrading the accuracy of the evaluation test on the fifth memory.

For this reason, there has been proposed a technique for mounting each of a plurality of internal circuits (circuit blocks) of an integrated circuit, or a power supply circuit for adjusting a supply voltage to a specified internal circuit, a measurement section for measuring a voltage value in this internal circuit and a control section for controlling the power supply circuit and the measurement section, in the interior of the integrated circuit (for example, see the following Patent Document 2).

There is a problem which arises with the conventional technique disclosed in the Patent Document 2, however, in that there is a need to place the power supply circuit, the measurement section, the control section and others in the interior of the integrated circuit, which complicates the circuit arrangement, requires a large installation space and increases the production cost.

In addition, according to this conventional technique, in the case of expecting a more accurate evaluation test, a power supply circuit is provided in all the internal circuits, which further complicates the circuit arrangement, requires a larger installation space and leads to a higher cost.

[Patent Document 1] Japanese Patent Laid-Open No. SHO 63-181457

[Patent Document 2] Japanese Patent Laid-Open No. 2002-365336

### SUMMARY OF THE INVENTION

The present invention has been developed in consideration of these problems mentioned above, and it is therefore an object of the invention to reliably detect supply voltages at a plurality of points of an integrated circuit with a simple arrangement and further to improve the setting accuracy of a supply voltage to the integrated circuit irrespective of position in the interior of the integrated circuit.

For this purpose, a power supply sense circuit according to the present invention, which is provided in the interior of an integrated circuit for detecting a supply voltage in the integrated circuit, comprises a plurality of voltage sense points, a selection circuit connected to each of the plurality of voltage sense points for selecting one voltage sense point of the plurality of voltage sense points on the basis of an input signal, and a voltage sense terminal connected to the selection circuit for outputting a voltage of the one voltage sense point, selected by the selection circuit, to the exterior of the integrated circuit.

Preferably, the plurality of voltage sense points are located at positions associated with a plurality of circuit blocks on the integrated circuit or a plurality of chip parts thereof.

In addition, preferably, the selection circuit is connected to a scan chain mounted on the integrated circuit so that the input signal is inputted through the scan chain.

Furthermore, for achieving the above-mentioned purpose, a power supply system according to the present invention comprises a power supply section for supplying power to an integrated circuit and includes, in the interior of the integrated circuit, a plurality of voltage sense points, a selection circuit connected to each of the plurality of voltage sense points for selecting one voltage sense point of the plurality of voltage sense points on the basis of an input signal, and a voltage sense terminal connected to the selection circuit for outputting a voltage of the one voltage sense point, selected by the selection circuit, to the exterior of the integrated circuit, with the power supply section adjusting power to be supplied to the integrated circuit on the basis of the voltage outputted from the voltage sense terminal.

Still furthermore, for achieving the above-mentioned purpose, an integrated circuit according to the present invention has a power supply sense circuit mounted for detecting a supply voltage, and the power supply sense circuit includes a plurality of voltage sense points, a selection circuit connected to each of the plurality of voltage sense points for selecting one voltage sense point of the plurality of voltage sense points on the basis of an input signal, and a voltage sense terminal connected to the selection circuit for outputting a voltage of the one voltage sense point, selected by the selection circuit, to the exterior of the integrated circuit.

Thus, according to the present invention, since provided are a plurality of voltage sense point, a selection circuit for selecting one of the plurality of voltage sense points and a voltage sense terminal for outputting a voltage of the one voltage sense point, selected by the selection circuit, to the external, it is possible to reliably detect the supply voltages at various spots (points) in the integrated circuit in a manner such that the selection circuit selects a plurality of voltage sense points according to an input signal.

In addition, since the present invention is realizable by only adding the plurality of voltage sense points and the selection circuit with respect to the conventional technique described above with reference to FIG. 5, the above-mentioned advantageous effects are attainable with an extremely simple arrangement.

Still additionally, the selection circuit can change the voltage sense points where voltages are sensed dynamically, which enables reliably sensing a voltage at a desired position on the integrated circuit, and the supply voltage can be adjusted on the basis of the sensed voltage value, thereby improving the setting accuracy of the supply voltage to the integrated circuit irrespective of position in the interior of the integrated circuit.

Yet additionally, the plurality of voltage sense points are located at positions associated with circuit blocks on the integrated circuit or chip parts thereof, which enables a voltage supplied to the circuit blocks or the chip parts to be detected with higher accuracy, thereby further improving the setting accuracy of a supply voltage to the circuit blocks or the chip parts.

Since the input signal to the selection circuit is inputted through a scan chain, there is no need to newly set up, on the integrated circuit, a facility for inputting this input signal, which can effectively utilize a packaging surface of the integrated circuit for high-density packaging and contribute to cost reduction.

### BRIEF DESCRIPTION OF THE DRAWINGS

FIG. 1 is a block diagram showing an arrangement of a power supply system according to an embodiment of the present invention;

FIG. 2 is a circuit diagram for explaining an configuration of a selector of a power supply system according to the embodiment of the present invention;

FIG. 3 is a circuit diagram for explaining an configuration of a selector of a power supply system according to the embodiment of the present invention;

FIG. 4 is a block diagram showing a configuration of a scan chain provided in a power supply system according to the embodiment of the present invention;

FIG. 5 is an illustration for explaining a configuration of a conventional power supply system; and

FIG. 6 is an illustration for explaining an example of an arrangement of a conventional integrated circuit.

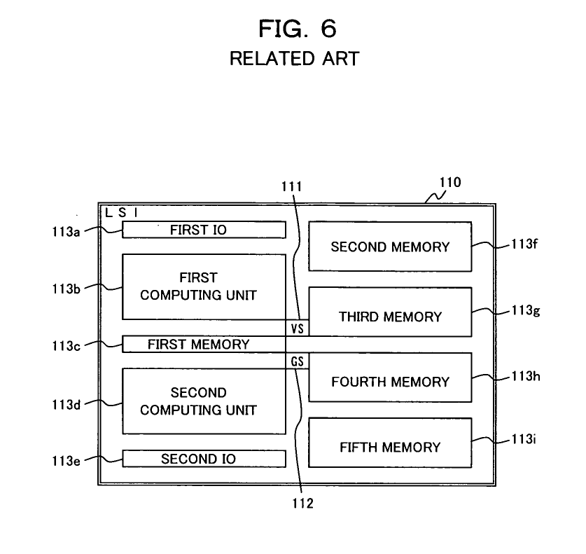

### DESCRIPTION OF THE PREFERRED EMBODIMENTS

Embodiments of the present invention will be described hereinbelow with reference to the drawings.

### [1] Embodiment of the Present Invention

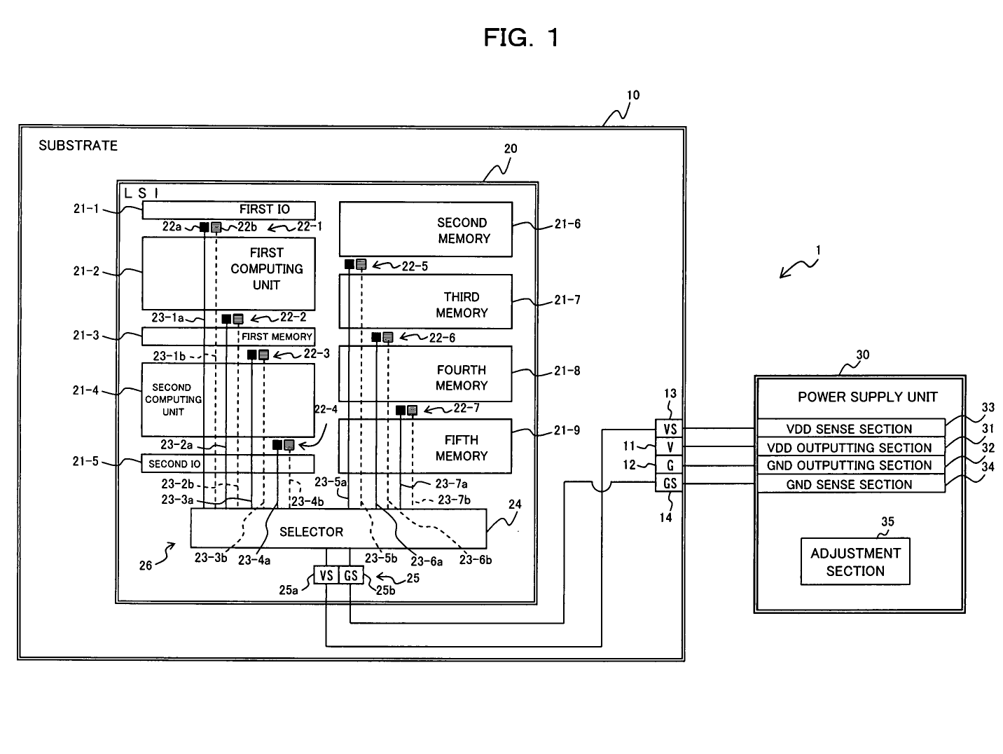

FIG. 1 is a block diagram showing a configuration of a power supply system according to an embodiment of the present invention. As shown in FIG. 1, a power supply system 1 according to this embodiment is arranged such that an integrated circuit (in this case, LSI (Large Scale Integration); which will hereinafter be referred to as LSI) 20 is mounted on a substrate 10 and a power supply unit (power supply section) 30 is connected to the substrate 10.

For receiving power supply from the power supply unit 30, the substrate 10 has a power supply terminal 11 (see “V” in the illustration) and a GND (ground) terminal 12 (see “G” in the illustration). The power supply terminal 11 is connected to a VDD outputting section 31 of the power supply unit 30 while the GND terminal 12 is connected to a GND outputting section 32 of the power supply unit 30, whereby the substrate 10 receives the supply of power from the power supply unit 30.

Incidentally, although not shown in FIG. 1, the power supply terminal 11 of the substrate 10 and the GND terminal 12 thereof are connected through wiring (not shown) on the substrate 10 to a power supply terminal (not shown) of the LSI 20 and a GND terminal (not shown) thereof, respectively, whereby power is supplied from the power supply unit 30 to the LSI 20 mounted on the substrate 10.

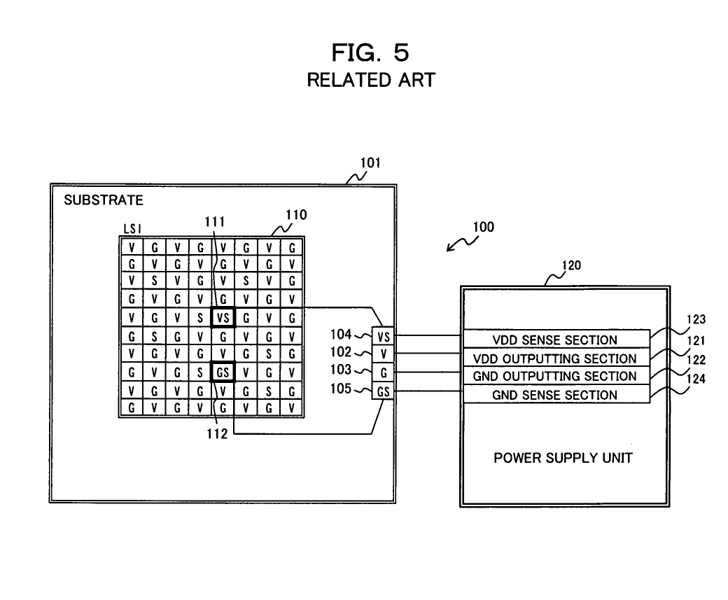

The power supply terminal of the LSI 20 equals the power supply terminal “V”, for example, shown in FIG. 5, and the GND terminal thereof equals the GND terminal “G”, for example, shown in FIG. 5.

In addition, for outputting a voltage value on the substrate 10 (in this case, a voltage value in the LSI 20) to the external, the substrate 10 has a first power supply voltage sense terminal 13 (see “VS” in the illustration) and a first GND voltage sense terminal 14 (see “GS” in the illustration).

Still additionally, the first power supply voltage sense terminal 13 is connected to a VDD sense section 33 of the power supply unit 30 while the first GND voltage sense terminal 14 is connected to a GND sense section 34 of the power supply unit 30, thereby enabling the power supply unit 30 to sense (monitor) a voltage value on the substrate 10 (in this case, a voltage value in the LSI 20).

Yet additionally, the power supply unit 30 includes an adjustment section 35 for adjusting power (supply voltage) to be supplied to the LSI 20 on the substrate 10 on the basis of a voltage value sensed by the VDD sense section 33 and the GND sense section 34.

The LSI 20 is made up of circuit blocks 21-1 to 21-9, voltage sense points 22-1 to 22-7, connection lines (wires) 23-1a to 23-7a and 23-1b to 23-7b, a selector (selection circuit) 24 and a voltage sense terminal 25.

The LSI 20 is divided into the plurality of circuit blocks 21-1 to 21-9, and the circuit block 21-1 functions as a first IO (Input/Output), the circuit block 21-2 functions as a first computing unit, the circuit block 21-3 functions as a first memory, the circuit block 21-4 functions as a second computing unit, the circuit block 21-5 functions as a second IO, the circuit block 21-6 functions as a second memory, the circuit block 21-7 functions as a third memory, the circuit block 21-8 functions as a fourth memory, and the circuit block 21-9 functions as a fifth memory.

Each of the plurality of voltage sense points 22-1 to 22-7 (in a case in which discrimination is not particularly made therebetween, the plurality of voltage sense points are merely designated at reference numeral “22”) is for detecting a supply voltage and comprises a VDD sense point 22a and a GND sense point 22b. In FIG. 1, the reference numeral “22” designating the VDD sense point (see a blackened square block in the illustration) and the reference numeral “22b” denoting the GND sense point (see a square block having a pattern of lateral stripes in the illustration) are written with respect to only the voltage sense point 22-1 as represented for simplification of illustration.

In addition, in the LSI 20, the voltage sense point 22-1 is placed between the circuit block 21-1 and the circuit block 21-2, the voltage sense point 22-2 is interposed between the circuit block 21-2 and the circuit block 21-3, the voltage sense point 22-3 is interposed between the circuit block 21-3 and the circuit block 21-4, the voltage sense point 22-4 is interposed between the circuit block 21-4 and the circuit block 21-5, the voltage sense point 22-5 is interposed between the circuit block 21-6 and the circuit block 21-7, the voltage sense point 22-6 is interposed between the circuit block 21-7 and the circuit block 21-8, and the voltage sense point 22-7 is interposed between the circuit block 21-8 and the circuit block 21-9.

Thus, the plurality of voltage sense points 22-1 to 22-7 are located at positions associated with the plurality of circuit blocks 21-1 to 21-9 (in a case in which discrimination is not particularly made therebetween, the plurality of voltage sense points are merely designated at reference numeral “21”), respectively. That is, the voltage sense points 22 are located to come close to the circuit blocks 21, and at least one voltage sense point 22 is located in the vicinity of each of the circuit blocks 21.

In this case, each of the plurality of voltage sense points 22 is interposed between two circuit blocks 21 to be distributed (scattered) throughout the entire LSI 20.

In addition, the VDD sense points 22a and the GND sense points 22b serving as the voltage sense points 22-1 to 22-7 are connected through connection lines 23-1a to 23-7a and 23-1b to 23-7b to a selector 24.

In this case, as shown in FIG. 1, with respect to the reference numerals 23-1a to 23-7a and 23-1b to 23-7b depicting the connection lines, the last-but-one reference numerals “1 to 7” correspond to the last reference numerals “1 to 7” of the reference numerals 22-1 to 22-7 denoting the voltage sense points, and the connection line and the voltage sense point, which have the same reference numerals, are connected to each other. Moreover, the rightmost reference mark “a” signifies the connection with the VDD sense point 22a while the rightmost reference mark “b” signifies the connection with the GND sense point 22b. For example, the connection line 23-1a is connected to the VDD sense point 22a of the voltage sense point 22-1 and the connection line 23-1b is connected to the GND sense point of the voltage sense point 22-1.

The selector 24 is connected through the connection lines 23-1a to 23-7a and 23-1b to 23-7b to the plurality of voltage sense points 22 for selecting one voltage sense point 22 from the plurality of voltage sense points 22 on the basis of an input signal from the external. The selector 24 is connected to a voltage sense terminal 25 for outputting the voltage of the voltage sense point 22 to the exterior of the LSI 20.

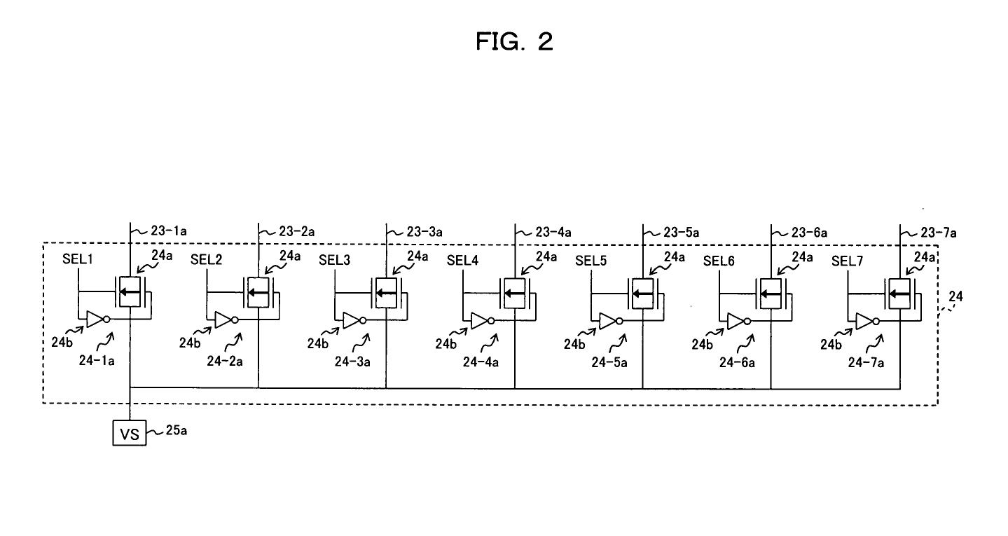

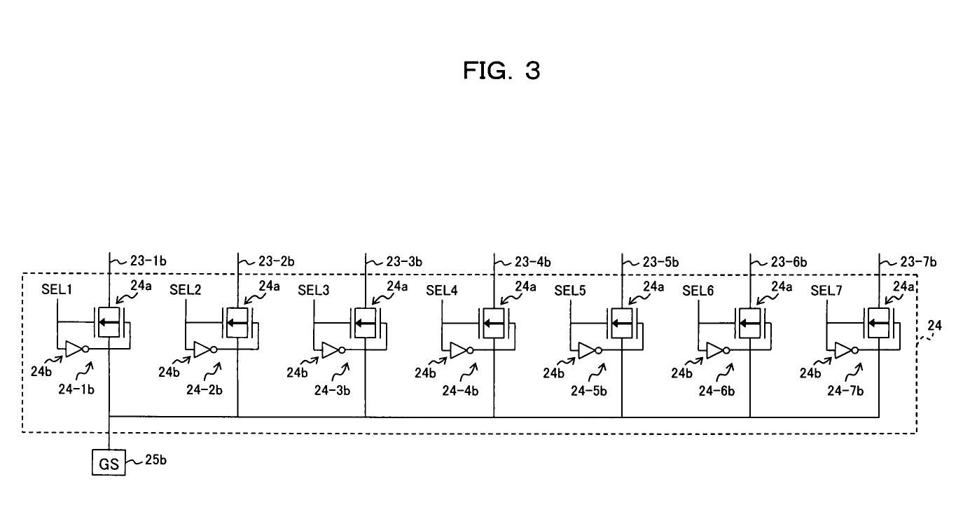

FIG. 2 and FIG. 3 are circuit diagrams showing an arrangement of the selector 24. As shown in FIG. 2, the selector 24 comprises selection circuits 24-1a to 24-7a each including a transistor 24a and a NOT gate 24b, and to these selection circuits 24-1a to 24-7a, there are connected the connection lines 23-1a to 23-7a connected to the VDD sense points 22a.

As shown in FIG. 2, with respect to the reference numerals 24-1a to 24-7a designating the selection circuits, the last-but-one reference numerals “1 to 7” correspond to the last reference numerals “1 to 7” of the connection lines 23-1a to 23-7a, and the selection circuit and the connection line which has the same reference numerals are connected to each other.

Moreover, each of the selection circuits 24-1a to 24-7a of the selector 24 is connected to a second voltage sense terminal 25a (see “VS” in the illustration) of the voltage sense terminal 25.

In addition, as shown in FIG. 3, the selector 24 comprises selection circuits 24-1b to 24-7b each including a transistor 24a and a NOT gate 24b, and to these selection circuits 24-1b to 24-7b, there are connected the connection lines 23-1b to 23-7b connected to the GND sense points 22b.

As shown in FIG. 3, with respect to the reference numerals 24-1b to 24-7b designating the selection circuits, the last-but-one reference numerals “1 to 7” correspond to the last reference numerals “1 to 7” of the connection lines 23-1b to 23-7b, and the selection circuit and the connection line which has the same reference numerals are connected to each other.

Moreover, each of the selection circuits 24-1b to 24-7b of the selector 24 is connected to a second GND sense terminal 25b (see “GS” in the illustration) of the voltage sense terminal 25.

Therefore, for example, when an input signal (expressed by “SEL1” in the illustration) for the selection of the voltage sense point 22-1 is inputted to the selector 24, in the selector 24, the voltage at the VDD sense point 22a of the voltage sense point 22-1 is outputted to the second power supply voltage sense terminal 25a of the voltage sense terminal 25 through the selection circuit 24-1a to which the connection line 23-1a is connected, and the voltage at the GND sense point 22b of the voltage sense point 22-1 is outputted to the second GND sense terminal 25b of the voltage sense terminal 25 through the selection circuit 24-1b to which the connection line 23-1b is connected.

As mentioned above, the voltage sense terminal 25 is for outputting a voltage at the voltage sense point 22 to the exterior of the LSI 20 and includes the second power supply voltage sense terminal 25a and the second GND sense terminal 25b.

In addition, the second power supply voltage sense terminal 25a is connected through wiring on the substrate 10 to the first power supply voltage sense terminal 13 provided on the substrate 10, and the second GND sense terminal 25b is connected through wiring on the substrate 10 to the first GND sense terminal 14 on the substrate 10, whereby the voltage of the voltage sense point 22 selected by the selector 24 is outputted through the first power supply voltage sense terminal 13 and the first GND sense terminal 14 to the power supply unit 30 for sensing this voltage.

In this power supply system 1, at least the plurality of voltage sense points 22, the selector 24 and the voltage sense terminal 25 function as a power supply sense circuit 26 in the LSI 20 to detect a supply voltage from the power supply unit 30.

Therefore, according to this power supply system 1, for example, when the circuit block 21-1 is on object of the evaluation test, for sensing the supply voltage to this circuit block 21-1, an input signal (SEL1) for selecting the voltage sense point 22-1 in the vicinity of the circuit block 21-1 is inputted to the selector 24.

Thus, in the selector 24, the selection circuit 24-1a connected through the connection line 23-1a to the VDD sense point 22a of the voltage sense point 22-1 and the selection circuit 24-1b connected through the connection line 23-1b to the GND sense point 22b of the voltage sense point 22-1 are activated on the basis of the input signal, thereby outputting the voltage at the voltage sense point 22-1 to the voltage sense terminal 25.

Secondly, the voltage at the voltage sense point 22-1 is outputted from the voltage sense terminal 25 through the first power supply voltage sense terminal 13 and the first GND sense terminal 14 to the power supply unit 30 to be sensed by the power supply unit 30.

In addition, the adjustment section 35 of the power supply unit 30 adjusts the power supply voltage to be supplied to the LSI 20 on the substrate 10 to a desired value on the basis of the sensed voltage value of the voltage sense point 22-1. For example, in a case in which the evaluation test is for verifying an operation of the circuit block 21-1 when the supply voltage is 1V, the adjustment section 35 carries out the feedback-control on the basis of the sensed voltage value so that the actual supply voltage value (that is, the sensed voltage value at the voltage sense point 22-1) in the circuit block 21-1 becomes a voltage value (in this case, 1V) for the test, thus adjusting the actual supply voltage value in the circuit block 21-1 to the voltage value for the test.

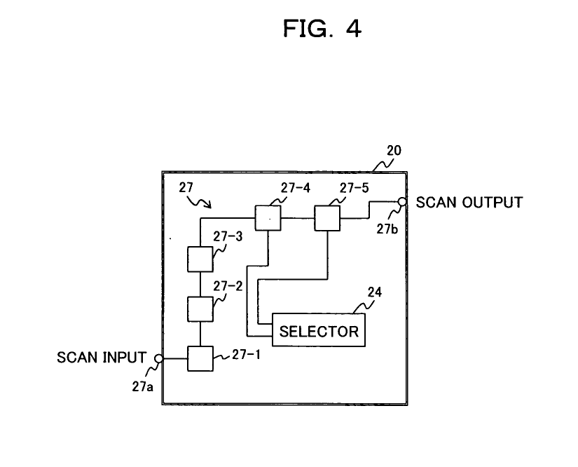

Furthermore, referring to FIG. 4, a description will be given hereinbelow of an arrangement for inputting an input signal to the selector 24 of the LSI 20. As shown in FIG. 4, the LSI 20 includes a scan chain 27 made in a manner such that an input terminal 27a, an output terminal 27b and a plurality of flip-flops (regular route circuit elements) 27-1 to 27-5 are connected in a moniliform fashion. This scan chain (shift register) 27 is used, for example, for BIST (Built In Self Test), and the LSI 20 inputs an input signal for the selection of a voltage sense point 22 to the selector 24 by utilizing the existing scan chain 27 which has been employed for other applications so far.

Concretely, the flip-flops 27-4 and 27-5 are connected to the selector 24 so that an input signal inputted from the input terminal 27a is inputted through the flip-flops 27-4 and 27-5 to the selector 24.

Therefore, in the LSI 20, it is possible to input an input signal through the use of the existing scan chain 27 without newly preparing a facility for inputting an input signal to the selector 24, which can achieve the effective utilization of a packaging surface of the LSI desiring high-density packaging and can contribute to the cost reduction.

As described above, since the power supply system 1 (power supply sense circuit 26) according to an embodiment of the present invention is made up of the plurality of voltage sense points 22, the selector 24 for selecting one of these plurality of voltage sense points 22 and the voltage sense terminal 25 for outputting a voltage of the one voltage sense point 22 selected by the selector 24 to the exterior of the LSI 20, the selector 24 can make a selection on the plurality of voltage sense points 22 according to an inputted signal so as to reliably sense the supply voltages at various places(points) in the interior of the LSI 20.

In addition, since it is possible to realize it only by adding the plurality of voltage sense points 22 and the selector 24 with respect to the conventional technique described above with reference to FIG. 5, the sensing of supply voltages at various positions in the interior of the LSI 20 becomes feasible with an externally simple arrangement.

Therefore, unlike the conventional technique disclosed in, for example, the aforesaid Patent Document 2, there is no need to mount a plurality of power supply circuits, a voltage measurement section, a control section and others on the LSI 20, thereby realizing the space-saving and cost reduction.

Still additionally, since the selector 24 can change the voltage sense points 22, where the voltage is sensed, dynamically, at an evaluation test on the LSI 20, the actual voltage value in the vicinity of the circuit block 21 which is an object of test is detectable with high accuracy in a manner such that the selector 24 switches the voltage sensing position to, of the plurality of voltage sense points 22, the voltage sense point 22 in vicinity of the circuit block which is the object of test. Yet additionally, the adjustment section 35 can adjust the supply voltage on the basis of this voltage value so that the supply voltage to the circuit block 21 which is the object of test equals a desired voltage for the test. That is, the setting accuracy of the supply voltage to the LSI 20 is improvable irrespective of position in the interior of the LSI 20.

Thus, for the evaluation test on the LSI 20, the supply voltage to the circuit block 21 which is an object of test can be set at a desired voltage for the test with high accuracy, thereby enabling a high-accuracy evaluation test.

Moreover, even when the LSI 20 is in operation, the selector 24 can select the voltage sense point 22 in the vicinity of the circuit block 21 which is in operation, which enables the voltage value of the circuit block 21 in operation to be detected with high accuracy. Still moreover, the adjustment section 35 can adjust the supply voltage on the basis of this voltage value, which enables the power supply to be accurately made to the circuit block 21 in operation.

If the selector 24 is configured with a simple circuit such as an analog switch, a simpler voltage sense circuit 26 becomes realizable.

In addition, since the plurality of voltage sense points 22 are respectively located at positions associated with the circuit blocks 21, the voltage supplied to the circuit block 21 is detectable with higher accuracy, which leads to further improvement of the setting accuracy of the supply voltage to the circuit block 21.

### [2] Others

It should be understood that the present invention is not limited to the above-described embodiment, and that it is intended to cover all changes and modifications of the embodiment of the invention herein which do not constitute departures from the spirit and scope of the invention.

For example, in the present invention, the position of the voltage sense point 22 is not limited to a position between the plurality of circuit blocks 22, but the voltage sense point 22 can also be disposed so as to approach at least the circuit block 21 while consideration is given to a space where the voltage sense points 22 can be mounted (i.e., space where the connection lines 23-1a to 23-7a and 23-1b to 23-7b can be wired).

Although in the above-described embodiment the substrate 10 of the power supply system 1 carries one LSI 20 as one example, the present invention is not limited to this, but it is also appropriate that a plurality of LSIs are mounted on the substrate 10. In this case, it is preferable that the voltage sense circuit 26 of the power supply system 1 according to the present invention is provided with respect to each of the plurality of LSIs mounted on the substrate 10.

Moreover, in a case in which the present invention is applied to a system LSI realized by mounting a small number of chip parts each having a dedicated function, it is preferable that the plurality of voltage sense points 22 are set at positions associated with the plurality of chip parts mounted on the system LSI, which can provide an advantageous effect similar to that of the above-described embodiment.

What is claimed is:

1. A power supply sense circuit provided in the interior of an integrated circuit for detecting a supply voltage in said integrated circuit, comprising:
a plurality of voltage sense points;
a selection circuit connected to each of said plurality of voltage sense points for selecting one of said plurality of voltage sense points on the basis of an input signal; and
a voltage sense terminal connected to said selection circuit for outputting a voltage of said one voltage sense point, selected by said selection circuit, to the exterior of said integrated circuit.

2. The power supply sense circuit according to claim 1, wherein said plurality of voltage sense points are respectively located at positions associated with a plurality of circuit blocks on said integrated circuit.

3. The power supply sense circuit according to claim 1, wherein said plurality of voltage sense points are respectively located at positions associated with a plurality of chip parts mounted on said integrated circuit.

4. The power supply sense circuit according to claim 1, wherein said selection circuit is connected to a scan chain mounted on said integrated circuit so that said input signal is inputted through said scan chain.

5. The power supply sense circuit according to claim 2, wherein said selection circuit is connected to a scan chain mounted on said integrated circuit so that said input signal is inputted through said scan chain.

6. The power supply sense circuit according to claim 3, wherein said selection circuit is connected to a scan chain mounted on said integrated circuit so that said input signal is inputted through said scan chain.

7. A power supply system comprising a power supply section for supplying power to an integrated circuit, and further comprising, in the interior of said integrated circuit,
a plurality of voltage sense points;
a selection circuit connected to each of said plurality of voltage sense points for selecting one of said plurality of voltage sense points on the basis of an input signal; and
a voltage sense terminal connected to said selection circuit for outputting a voltage of said one voltage sense point, selected by said selection circuit, to the exterior of said integrated circuit,
said power supply section adjusting power to be supplied to said integrated circuit on the basis of said voltage outputted from said voltage sense terminal.

8. The power supply system according to claim 7, wherein said plurality of voltage sense points are respectively located at positions associated with a plurality of circuit blocks on said integrated circuit.

9. The power supply system according to claim 7, wherein said plurality of voltage sense points are respectively located at positions associated with a plurality of chip parts mounted on said integrated circuit.

10. The power supply system according to claim 7, wherein said selection circuit is connected to a scan chain mounted on said integrated circuit so that said input signal is inputted through said scan chain.

11. The power supply system according to claim 8, wherein said selection circuit is connected to a scan chain mounted on said integrated circuit so that said input signal is inputted through said scan chain.

12. The power supply system according to claim 9, wherein said selection circuit is connected to a scan chain mounted on said integrated circuit so that said input signal is inputted through said scan chain.

13. An integrated circuit having a power supply sense circuit mounted for detecting a supply voltage, and said power supply sense circuit including:
a plurality of voltage sense points;
a selection circuit connected to each of said plurality of voltage sense points for selecting one of said plurality of voltage sense points on the basis of an input signal; and
a voltage sense terminal connected to said selection circuit for outputting a voltage of said one voltage sense point, selected by said selection circuit, to the exterior of said integrated circuit.

14. The integrated circuit according to claim 13, wherein said plurality of voltage sense points of said power supply sense circuit are respectively located at positions associated with a plurality of circuit blocks on said integrated circuit.

15. The integrated circuit according to claim 13, wherein said plurality of voltage sense points of said power supply sense circuit are respectively located at positions associated with a plurality of chip parts mounted on said integrated circuit.

16. The integrated circuit according to claim 13, wherein said selection circuit of said power supply sense circuit is connected to a scan chain mounted on said integrated circuit so that said input signal is inputted through said scan chain.

17. The integrated circuit according to claim 14, wherein said selection circuit of said power supply sense circuit is connected to a scan chain mounted on said integrated circuit so that said input signal is inputted through said scan chain.

18. The integrated circuit according to claim 15, wherein said selection circuit of said power supply sense circuit is connected to a scan chain mounted on said integrated circuit so that said input signal is inputted through said scan chain.
